(19) United States
(12) Patent Application Publication
(10) Pub. No.: US 2008/0172367 A1
(43) Pub. Date: Jul. 17, 2008

(54) SEARCH METHOD, APPARATUS AND PROGRAM

(75) Inventor: Wataru IGARASHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/960,774

(22) Filed: Dec. 20, 2007

(30) Foreign Application Priority Data
Jan. 12, 2007 (JP) 2007-4860

(51) Int. Cl. G06F 17/30

(52) U.S. Cl. 707/3; 707/E17.014

(57) ABSTRACT

A search method and apparatus which searches for a store handling commodities including receiving a search keyword relating to a targeted commodity, as a condition, searching, based on the search keyword relating to the targeted commodity, a stock database of each store, extracting information of each store having the targeted commodity in stock as a first extracted store, searching the stock database based on data of the targeted commodity, extracting information of a store as a second extracted store, and transmitting data of the second extracted store to the search request source terminal.

### CROSS-REFERENCE TO RELATED APPLICATIONS

This application is related to and claims the benefit of priority from JP2007-004860, filed on Jan. 12, 2007, the entire contents of which are incorporated herein by reference.

### BACKGROUND

1. Field

The present invention relates to a data search technology, and more particularly, to a technology which searches for a store handling commodities.

2. Description of the Related Art

Generally, according to a current map search service, when a “commodity A” is input as a search condition, as shown in FIG. 1, all stores handling the “commodity A” are uniformly displayed with pins or indicators on a map. However, in the event that there are a large number of stores handling a commodity, a large number of pins are displayed, and the map becomes hard to read. Also, as shown in FIG. 2, although a user using the map search service intends to select one pin to display detailed information, since there is no reference information as to which pin is to be selected, there is no alternative for the user but to make a blind selection. However, once the user knows a store having a large stock of related commodities, the user wants to make a selection. This is because, in the case of the store that has the large stock of related commodities, there is generally a possibility that the store also has a well-experienced and well-informed salesperson that is of service.

Further, JP-A-2002-14968 discusses a technology for finding a commodity or a service relating to a book desired by a user. Specifically, when a server device is accessed from a terminal device, and search condition information of the book is input from the terminal device, the server device supplies the terminal device with not only information of a book conforming to the search condition information, but information of the commodity or service fixed in advance as one relating to the book, and causes the information to be displayed in the terminal device. However, this and other similar technologies do not extract a dealer store taking a stock status into account. Further, the technology is not one which presents a selection unique to each store.

### SUMMARY

The disclosed search method and apparatus are enabled to execute searches for a store handling commodities. The method includes receiving a search keyword relating to a targeted commodity, as a condition of extracting information of a store which sells the targeted commodity, from a search request source terminal, searching, based on the search keyword relating to the targeted commodity, a stock database which of each store managing data relating to contents of the commodities and stock data of the commodities, and extracting information of a store having the targeted commodity in stock as a first extracted store, and storing corresponding information in a storage device.

The disclosed method includes searching the stock database based on data of the targeted commodity, extracting information of a store, which is the first extracted store and has in stock a related commodity relating to the data of the targeted commodity, as a second extracted store, and storing corresponding information in the storage device; and transmitting data of the second extracted store stored in the storage device to the search request source terminal.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram showing an example of a typical display screen providing results of a search;

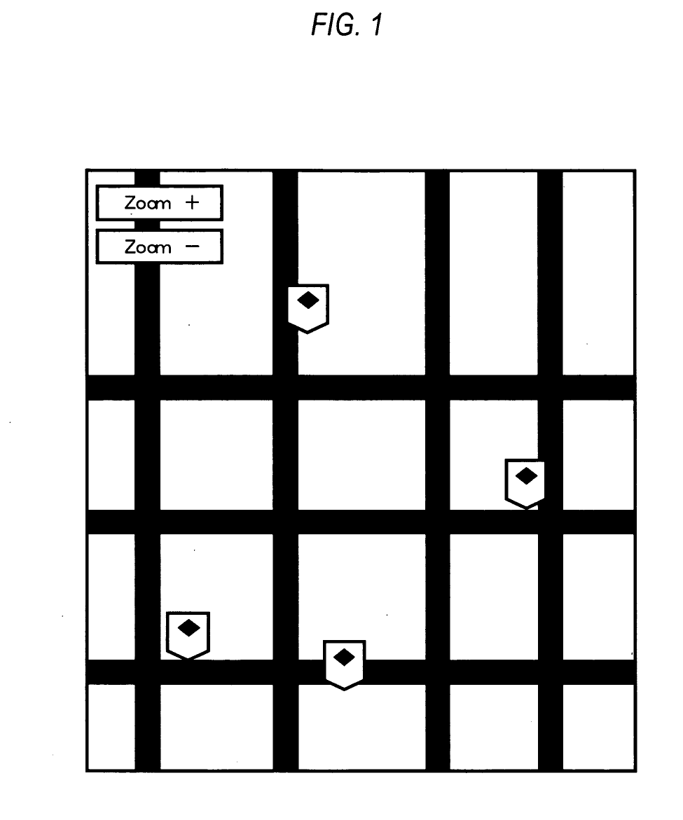

FIG. 2 is a diagram showing an example of the known display screen providing additional results of a search;

FIG. 3 is a schematic diagram of a system in an embodiment of the invention;

FIG. 4 is a functional block diagram of a specialty store search system;

FIG. 5 is a diagram illustrating one example of data stored in a bookstore DB;

FIG. 6 is a diagram illustrating one example of data stored in a book DB;

FIG. 7 is a diagram illustrating one example of data stored in a stock DB;

FIG. 8A is a diagram illustrating a process flow in the embodiment of the invention;

FIG. 8B is a diagram illustrating a process flow in the embodiment of the invention;

FIG. 9 is a view illustrating one example of a search condition input screen;

FIG. 10 is a view illustrating an example of a search result display screen;

FIG. 11 is a view illustrating an example of a search result display screen; and

FIG. 12 is a functional block diagram of a computer.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

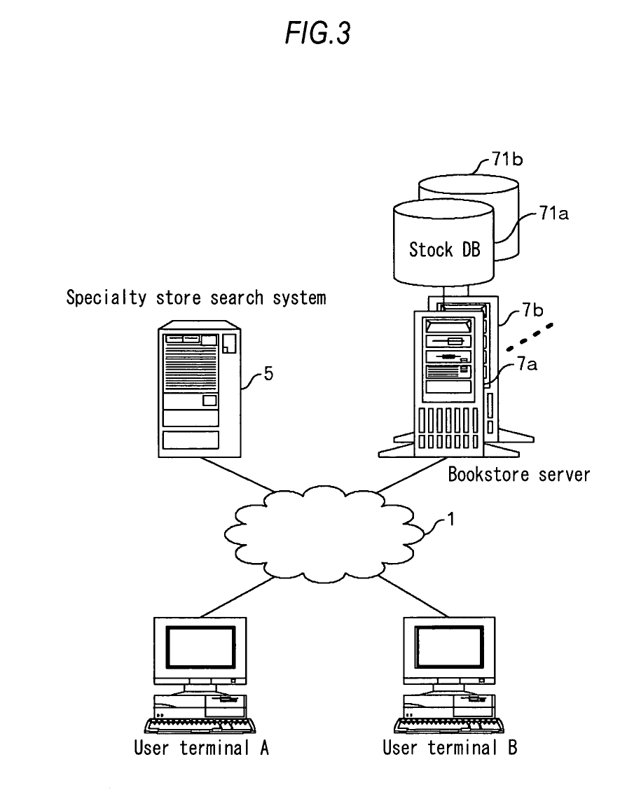

FIG. 3 illustrates an exemplary configuration of a system. As shown in FIG. 3, the disclosed system includes a network 1 connecting a specialty store search system 5, a bookstore server 7, a stock database (DB) 71. A plurality of user terminals (user terminals A and B in FIG. 3), a plurality of bookstore servers 7 (bookstore servers 7a and 7b in FIG. 3), and a specialty store search system 5 may be connected with a network 1 which is, for example, an Internet. Each bookstore server 7 manages a stock DB 71 (a stock DB 71a or 71b in FIG. 3). Although, the commodity is exemplified as a book, the present invention is not limited to conducting a search of a particular commodity. Instead, the disclosed system and method may be used with various types of commodities of which a stock is managed.

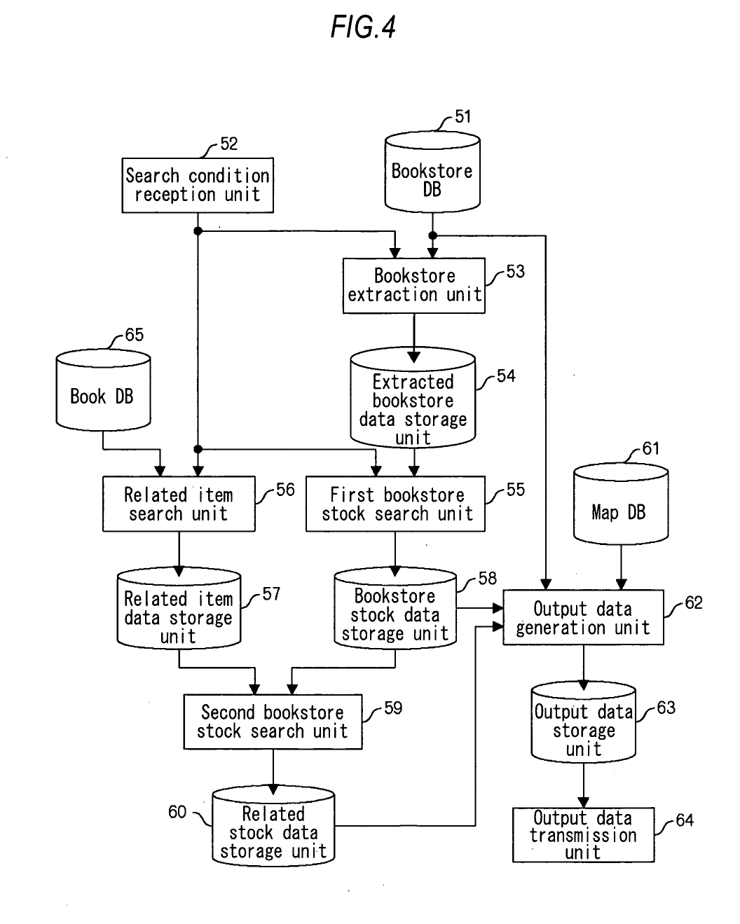

The specialty store server 5 may also include processing units and DBs such as those shown in FIG. 4. As illustrated in FIG. 4, the disclosed system may include a bookstore DB 51, a search condition reception unit 52, a bookstore extraction unit 53, an extracted bookstore data storage unit 54, a first bookstore stock search unit 55, a related item search unit 56, a related item data storage unit 57, a bookstore stock data storage unit 58, a second bookstore stock search unit 59, a related stock data storage unit 60, a map DB 61, an output data generation unit 62, an output data storage unit 63, an output data transmission unit 64, and a book DB 65.

The bookstore DB 51 stores bookstore location data, etc., the search condition reception unit 52 receives search conditions from a user terminal via the network 1, and the bookstore extraction unit 53 searches the bookstore DB 51 based on a location search condition received by the search condition reception unit 52, and extracts information of a corresponding bookstore. As illustrated in FIG. 4, the extracted bookstore data storage unit 54 stores a result of a process of the bookstore extraction unit 53, the first bookstore stock search unit 55 searches a stock DB 71 of a corresponding bookstore, using a search condition (herein a search keyword) received by the search condition reception unit 52, and the extracted bookstore data stored in the extracted bookstore data storage unit 54. The bookstore stock data storage unit 58 stores a result of the process of the first bookstore stock search unit 55, and the book DB 65 stores data relating to books. As mentioned above, while description is provided using a book as an exemplary commodity, the present invention is not limited to a search related thereto. Further, a store may be any provider offering a commodity or service to a user.

The related item search unit 56 searches the book DB 65 based on search conditions (herein a related item and a search keyword) received by the search condition reception unit 52 and the related item data storage unit 57 stores a result of the process of the related item search unit 56. The second bookstore stock search unit 59 illustrated in FIG. 4 searches the stock DB 71 of a corresponding bookstore, using data stored in the related item data storage unit 57 and the bookstore stock data storage unit 58. A related stock data storage unit 60 stores a result of a process of the second bookstore stock search unit 59. A map DB 61 stores map data. An output data generation unit 62 generates output data, using the data stored in the bookstore DB 51, the bookstore stock data storage unit 58, the related stock data storage unit 60 and the map DB 61. An output data storage unit 63 stores a result of the process of the output data generation unit 62. An output data transmission unit 64 transmits the data stored in the output data storage unit 63 to the user terminal which is a search request source.

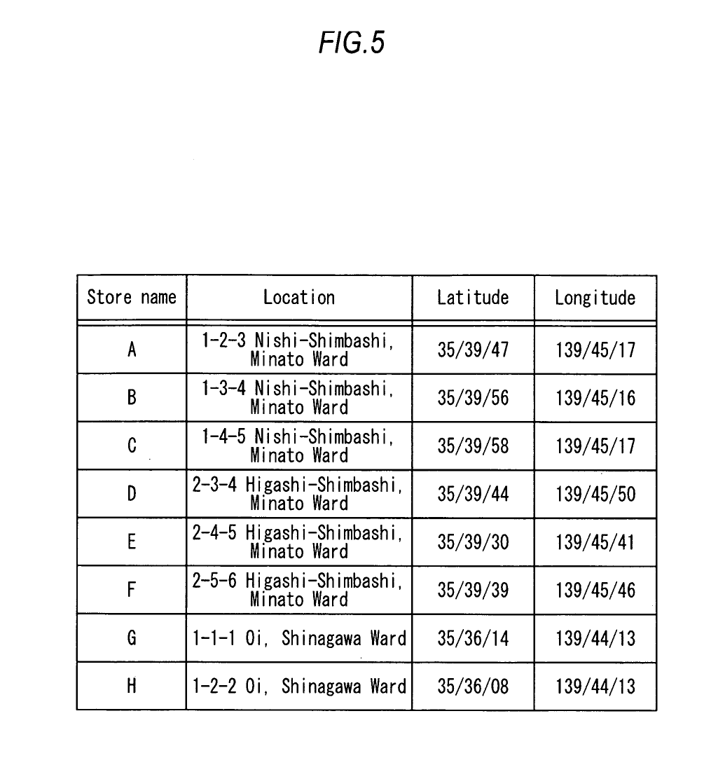

FIG. 5 shows an example of data stored in the bookstore DB 51. As illustrated in FIG. 5, a store name, a location (displayed with an address), a latitude and a longitude are registered. While FIG. 5 is described with particular items in the bookstore DB 51, the present invention is not limited to these items and may include various attributes and information of a store identifying a location of the store.

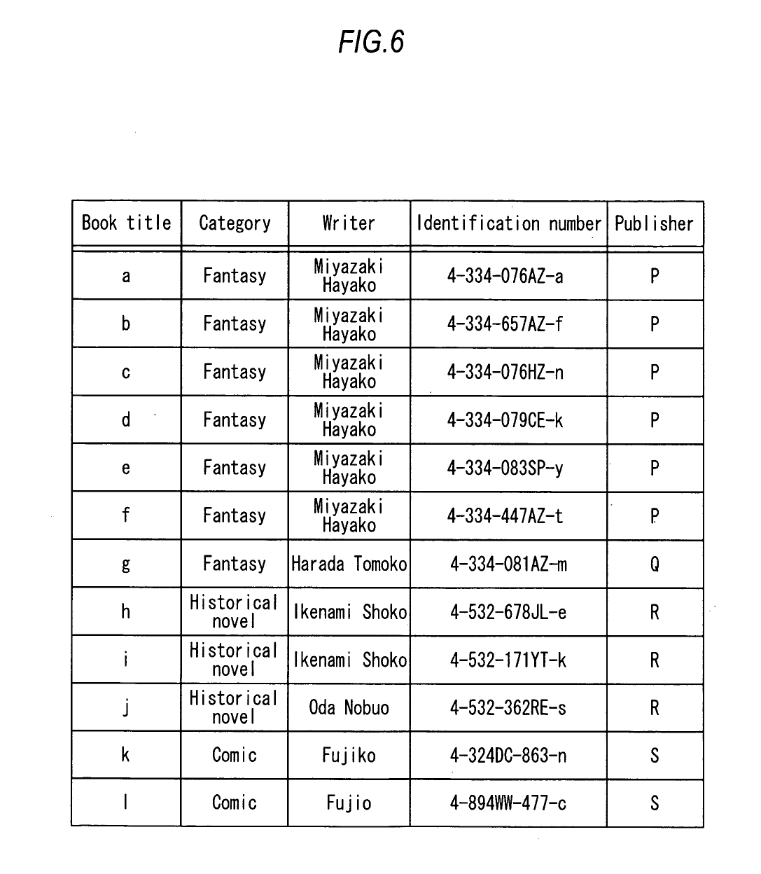

FIG. 6 shows an example of data stored in the book DB 65. As illustrated in FIG. 6, a book title, a category, a writer, an identification number allotted to a book, and a publisher may be registered.

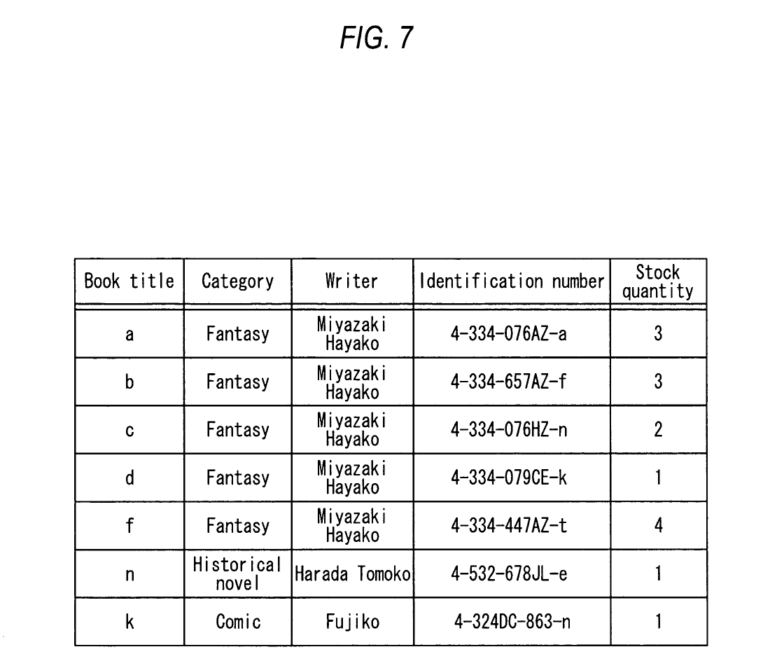

FIG. 7 shows an example of data stored in the stock DB 71 (for example, a stock DB 71a of a bookstore A). As illustrated in FIG. 7, a book title, a category, a writer, an identification number allotted to a book, and a quantity of books which a bookstore (for example, the bookstore A) has in stock, may be registered.

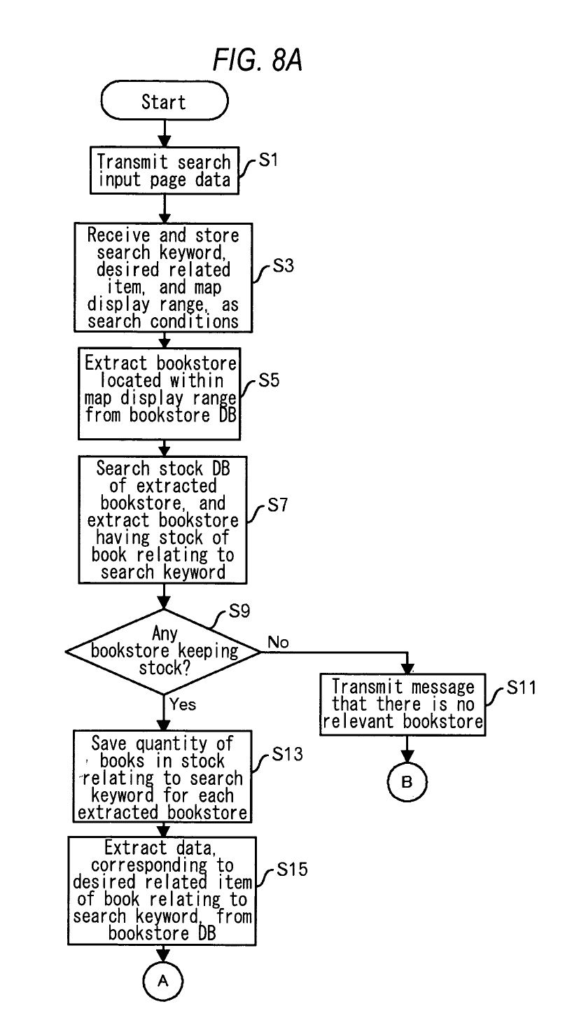

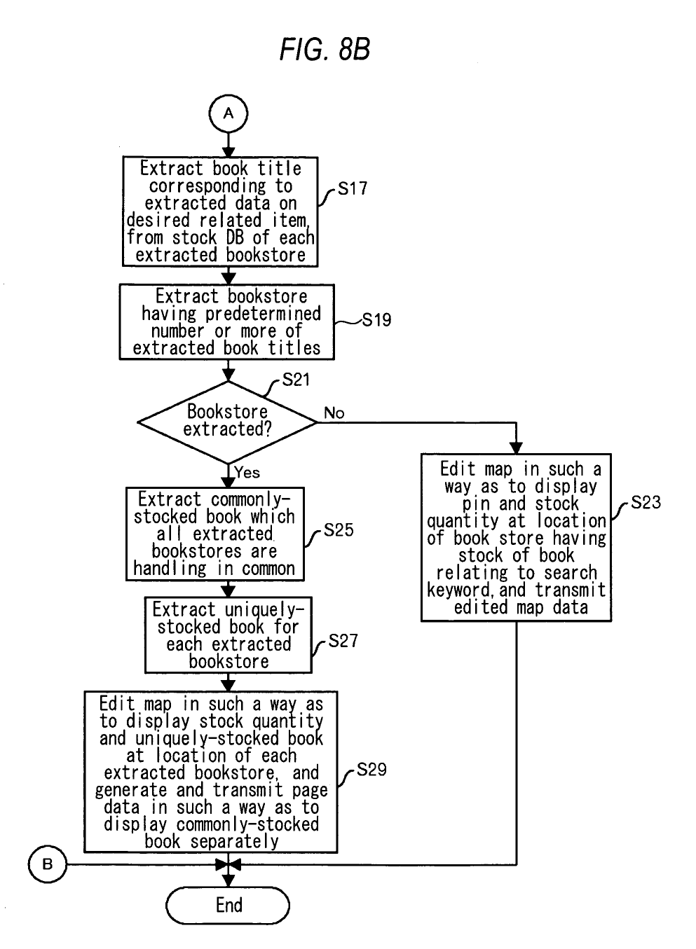

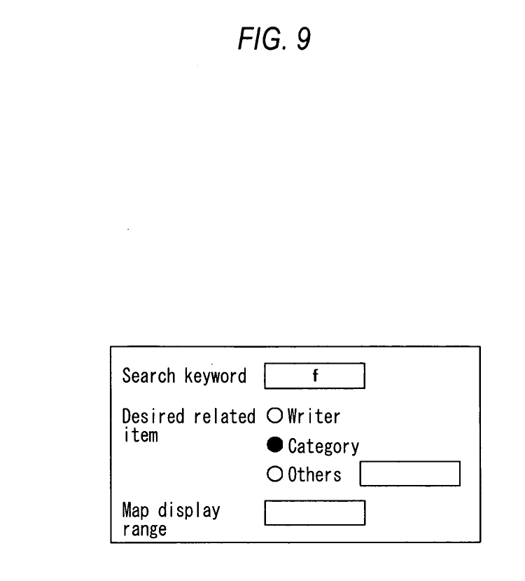

Next, a description will be given, using FIGS. 8A and 8B, of process details of the specialty store search system 5 shown in FIG. 4. First, the search condition reception unit 52, upon receiving an access to a search input page from, for example, the user terminal A, transmits search input page data to the user terminal A (operation S1). The user terminal A receives the search input page data from the specialty store search system 5, and displays the page data on a display device. For example, a screen illustrated in FIG. 9 is displayed. As illustrated in FIG. 9, an input box for a search keyword of a book title, a selection field enabling selection of a desired related item to be extracted for a book extracted based on the search keyword, and an input box for a map display range which geometrically limits or specifies a bookstore to be searched for, are provided in the search input page. Radio buttons or other selection controls for selecting one of the writer, the category or others, and an input box in a case of selecting the others, are provided in the desired related item selection field. Further, the map display range may be set on another screen. For example, an arrangement enabling the user to input an address, etc in the map display range input box may be provided.

When the user inputs a search condition on the kind of screen of FIG. 9, and instructs the user terminal A to transmit data of the search condition to the specialty store search system 5, the user terminal A, in response to the instruction, transmits data on the input search condition to the specialty store search system 5.

The search condition reception unit 52 of the specialty store search system 5 receives data of the search keyword and the desired related item as the search conditions, and data on the map display range, and stores the data in a storage device such as a main memory, etc. (operation S3). Then, the search condition reception unit 52 transmits the map display range data to the bookstore extraction unit 53 and transmits the search keyword to the first bookstore stock search unit 55. Furthermore, the search condition reception unit 52 transmits the data on the search keyword and the desired related item to the related item search unit 56.

The bookstore extraction unit 53 receives the map display range data, searches the bookstore DB 51 based on the map display range data, extracts a store located within the map display range, and stores identification data of the store in the extracted bookstore data storage unit 54 (operation S5). For example, presuming that “Minato Ward” is designated as the map display range, the bookstore extraction unit 53 extracts A to F, shown in FIG. 5, from the bookstore DB 51.

Further, the first bookstore stock search unit 55 accesses the bookstore server 7 of each extracted bookstore stored in the extracted bookstore data storage unit 54, and searches the stock DB 71 based on a search keyword. Then, the first bookstore stock search unit 55 extracts information of a bookstore having a stock of a book relating to the search keyword, and stores identification data relating to the store in the bookstore stock data storage unit 58 (operation S7). For example, in the event that “a” is set for a book title relating to the search keyword, it is taken that, for example, information of a bookstore A, a bookstore B, a bookstore C and a bookstore D are extracted. In the event that there are any books in stock, a quantity of the books in stock is also extracted from the stock DB 71.

Then, the output data generation unit 62 determines whether information of a bookstore having the stock can be extracted (operation S9). If no bookstore having the stock exists, the output data generation unit 62 generates a message “no corresponding bookstore”, and stores the generated data in the output data storage unit 63. Then, the output data transmission unit 64 transmits the message to the user terminal A which is the search request source (operation S11). Then, the search process based on the requested search condition is finished.

If a bookstore having the stock exists, the output data generation unit 62 stores the quantity of the books in stock relating to the search keyword, for each extracted store, in the bookstore stock data storage unit 58 (operation S13). Data, for example, “4” for the bookstore A, “2” for the bookstore B, “3” for the bookstore C, and “1” for the bookstore D, are stored in the bookstore stock data storage unit 58.

Next, the related item search unit 56 extracts data, corresponding to the desired related item of the books relating to the search keyword, from the book DB 65, and stores the extracted data in the related item data storage unit 57 (operation S15). For example, in the event that the desired related item is the category, and the search keyword is “a”, the book DB 65 is searched based on the search keyword “a”, and a category “fantasy” is extracted. Then, the search process shifts to the process of FIG. 8B via the terminal A.

Shifting to a description of FIG. 8B, the second bookstore stock search unit 59 accesses the bookstore server 7 of each extracted bookstore stored in the bookstore stock data storage unit 58. Then, the second bookstore stock search unit 59 extracts a book title, corresponding to the extracted data of the desired related item, which is stored in the related item data storage unit 57, from the stock DB 71, and stores the extracted data in the related stock data storage unit 60 (operation S17). Naturally, a book title of a book in stock is extracted. As, in the above example, “fantasy” is the extracted data on the desired related item, a search based on “fantasy” is carried out for each stock DB 71, and a book title of a book in stock, which corresponds to “fantasy”, is extracted.

For example, “a, b, c, d and f” are extracted for the bookstore A, “f and g” are extracted for the bookstore B, “a, b, e and f” are extracted for the bookstore C, and “f” is extracted for the bookstore D.

Then, the second bookstore stock search unit 59 extracts information of a bookstore having a predetermined number or more of extracted book titles stored in the related stock data storage unit 60, and sets a flag, in the related stock data storage unit 60, for the extracted bookstore (operation S19). For example, in the event that the predetermined number is “3”, in the above example, the bookstore A and the bookstore C are extracted, and flags are set.

Subsequently, the output data generation unit 62, referring to the related stock data storage unit 60, determines whether a bookstore for which a flag is set exists (operation S21). When determining that no bookstore for which the flag is set exists, the output data generation unit 62 searches the bookstore DB 51 for an extracted bookstore information stored in the bookstore stock data storage unit 58 (that is, a bookstore having the stock of the book relating to the search keyword). Then, the output data generation unit 62 specifies a display area by extracting location data corresponding to the extracted bookstore, and extracts map data on the display area from the map DB 61. Furthermore, the output data generation unit 62 edits the map data in such a way as to display a pin, a mark or an indicator and a stock quantity at a location of the extracted bookstore, and stores the edited map data in the output data storage unit 63. Then, the output data transmission unit 64 transmits the edited map data stored in the output data storage unit 63 to the user terminal A which is the search request source (operation S23). Then, the series of processes is finished.

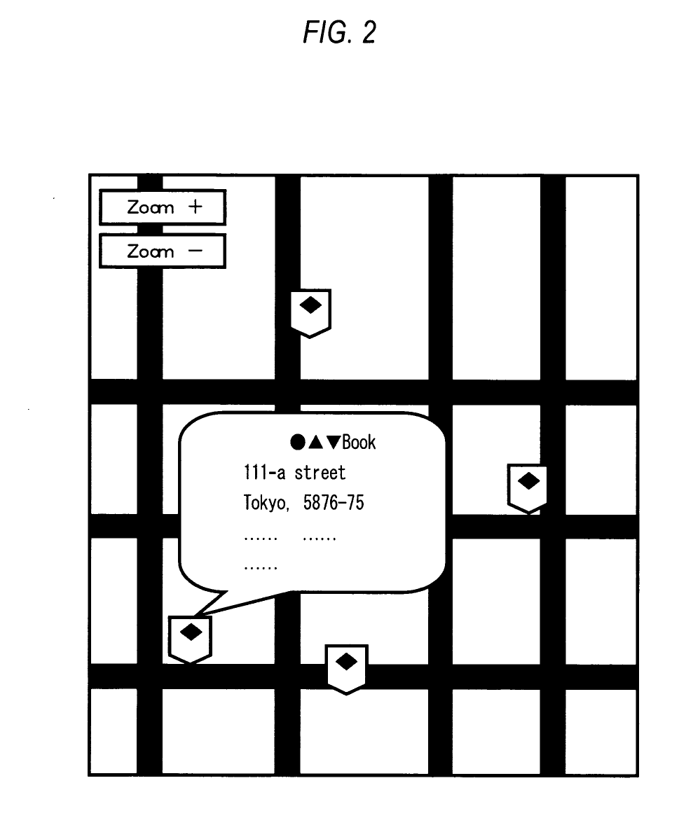

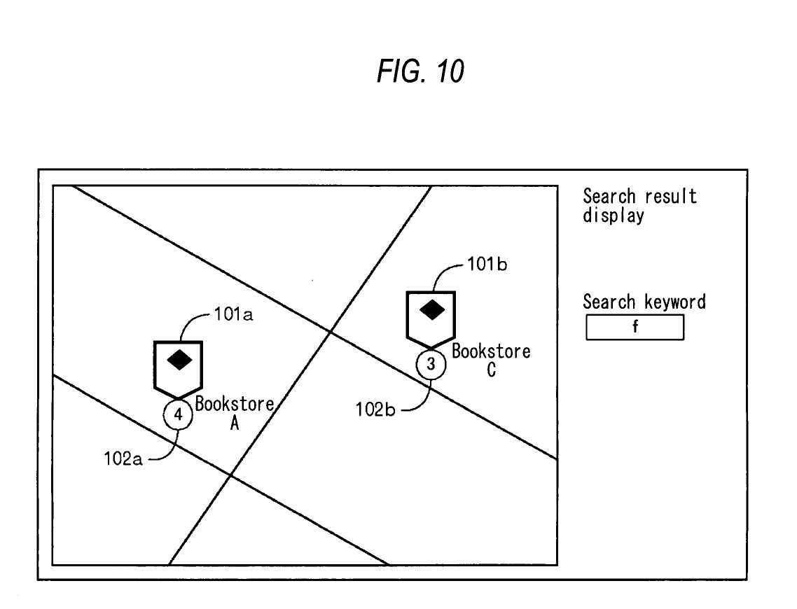

The user terminal A receives the edited map data from the specialty store search system 5, and displays the map data on the display device. For example, a screen such as that shown in FIG. 10 is displayed. The example of FIG. 10 shows a case in which the bookstore A and the bookstore C are stored in the bookstore stock data storage unit 58. A pin 101 a (indicator) and a quantity 102a of books in stock set as the search condition by the user are shown at the location of the bookstore A. In the same way, a pin 101b (or indicator) and a stock quantity 102b are shown at the location of the bookstore C. In the event that either the pin 101a or the pin 101b is clicked or selected, detail information of store(s), such as, for example, information shown in FIG. 2, may be displayed.

In operation S21, contrarily, when determining that the bookstore for which the flag is set exists, the output data generation unit 62 retrieves book titles in each bookstore which are stored in the related stock data storage unit 60, extracts a commonly-stocked book, which is commonly handled by all the bookstores extracted in operation S19, and stores the extracted information in the output data storage unit 63 (operation S25). For example, information of the bookstore A and the bookstore C are extracted in operation S19 and, as “a, b, c, d and f” are extracted for the bookstore A, and “a, b, e and f” are extracted for the bookstore C, the commonly-stocked books are identified as “a, b and f”.

Also, the output data generation unit 62 extracts information of a uniquely-stocked book, a stock of which no other bookstore has, from each bookstore extracted in operation S19, and stores the extracted information in the output data storage unit 63 (operation S27). In the heretofore described example, “c and d” are extracted as the uniquely-stocked books for the bookstore A, and “e” is extracted as the uniquely-stocked book for the bookstore B.

Then, the output data generation unit 62 searches the bookstore DB 51 for a location of each bookstore extracted in operation S19 (each bookstore which is stored in the related stock data storage unit 60 and for which a flag is set), specifies a display area, and extracts map data on the display area from the map DB 61. Furthermore, the output data generation unit 62 edits the map data in such a way as to display the stock quantity and the uniquely-stocked book at each bookstore location, generates page data in such a way as to display the commonly-stocked book separately, and stores them in the output data storage unit 63. Then, the output data transmission unit 64 transmits the page data stored in the output data storage unit 63 to the user terminal A which is the search request source (operation S29). Then, the series of processes is finished.

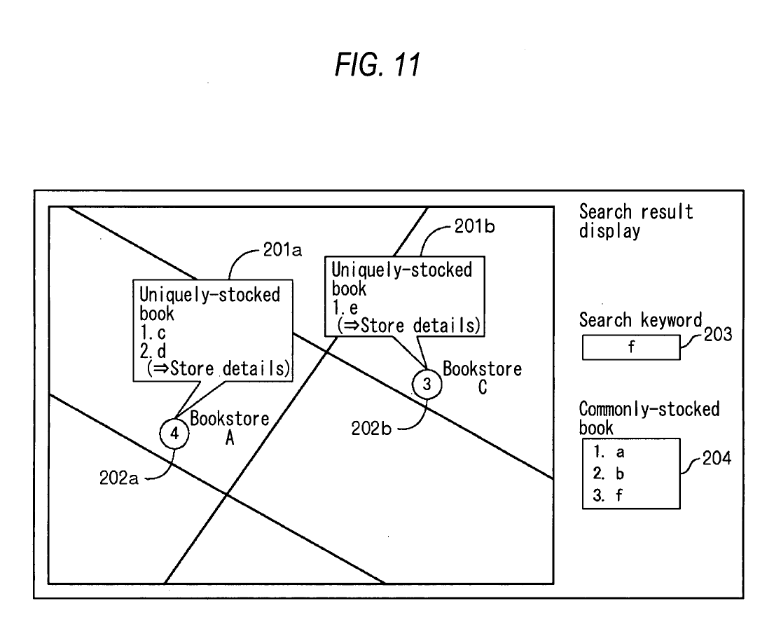

The user terminal A receives the page data from the specialty store search system 5, and displays the page on the display device. A screen such as, for example, illustrated in FIG. 11 is displayed. In the example of FIG. 11, an arrangement is such that a tag 201a including information of the uniquely-stocked books (c and d) and a link to a store detail page, and a stock quantity 202a, are displayed at the location of the bookstore A. Also, an arrangement such that a tag 201b including the uniquely-stocked book “e” and the link to the store detail page, and a stock quantity 202b, are displayed at the location of the bookstore C. Furthermore, an arrangement such that a display box 203 for the input search keyword, and a display box 204 for the commonly-stocked books “a, b and f”, are displayed in a margin of the map.

Accordingly, a user can refer, on the map, to a bookstore which has a stock of a book corresponding to the search keyword, and furthermore, has a stock of a predetermined number or more of other books, common to data which correspond to the desired related item of the book corresponding to the search keyword. As a number of bookstores to be displayed is reduced in this way, the disclosed system and method enabling an easy selection of a bookstore, it is easy to carry out a tag display.

Furthermore, as the uniquely-stocked book is also presented, it is possible to select a bookstore, taking into account a selection of related books too. That is, it is possible to recognize a difference in individuality between bookstores.

Also, as the stock quantity is also presented, the user can select a bookstore which he or she will visit, taking into account the stock quantity too.

FIG. 11 being one example, it is also acceptable to arrange in such a way as, for example, to display a pin or an indicator at a location of a bookstore, and carry out the tag display when the pin is clicked. Also, it is also acceptable to arrange in such a way that the commonly-stocked books are displayed as a list, included in and not separated from the tag display.

As mentioned above, the description has been given of an embodiment of the invention, but the invention is not limited to any particular embodiment. For example, FIG. 3 shows the example in which the bookstore server 7 manages the stock DB 71 of each bookstore, but to the disclosed system and method may employ a kind of system configuration in which the specialty store search system 5 manages the stock DB 71 of each bookstore.

Also, the functional block diagram shown in FIG. 4 being one example, there is also a case in which it differs from an actual program configuration.

Furthermore, although the screen configuration has been described heretofore, it is also acceptable to employ a differing configuration. It is also acceptable to arrange in such a way as to change a color in accordance with a selection quantity, or change the color in accordance with the stock quantity.

Also, it is also acceptable to arrange in such a way that the specialty store search system 5 is configured of a plurality of computers rather than one computer.

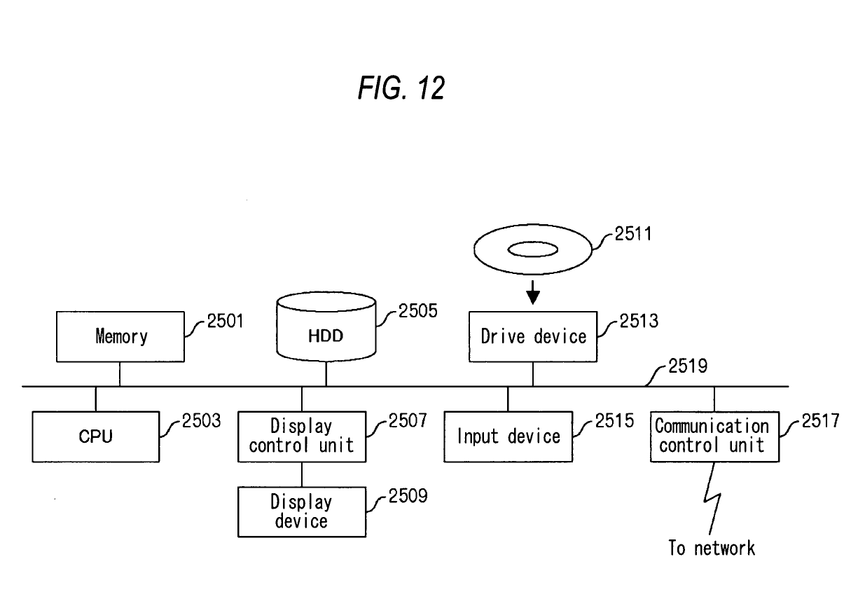

The specialty store search system 5, the user terminal, and the bookstore server 7, shown in FIG. 3, are computer apparatus and, as shown in FIG. 12, in the computer apparatus, a memory 2501 (a storage unit), a CPU 2503 (a processing unit), a hard disk drive (an HDD) 2505, a display control unit 2507 connected with a display device 2509, a drive device 2513 for a removable disk 2511, an input device 2515, and a communication control unit 2517 for enabling a connection with a network, are connected by a bus 2519. An operating system (OS) and an application program including a Web browser may be stored in the HDD 2505 and, when being executed by the CPU 2503, are read from the HDD 2505 to the memory 2501. When needed, the CPU 2503 controls the display control unit 2507, the communication control unit 2517 and the drive device 2513, and causes them to carry out necessary operations. Also, data being processed are stored in the memory 2501 and, when occasion requires, are stored in the HDD 2505. This kind of computer realizes various kinds of function, such as the heretofore described ones, by hardware, such as the heretofore described CPU 2503 and memory 2501, cooperating organically with the OS and necessary application program.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A search method which searches for a store handling commodities, comprising:
receiving a search keyword relating to a targeted commodity, as a condition of extracting information of a store which sells the targeted commodity, from a search request source terminal;
searching, based on the search keyword relating to the targeted commodity, a stock database of each store managing data relating to contents of commodities and stock data of the commodities, extracting information of each store having the targeted commodity in stock as a first extracted store, and storing corresponding information;
searching the stock database based on data of the targeted commodity, extracting information of a store indicated as the first extracted store and has in stock a related commodity relating to the data of the targeted commodity, as a second extracted store, and storing corresponding information; and
transmitting data of the second extracted store stored to the search request source terminal.

2. The search method according to claim 1, wherein
the transmitting includes
searching a store database storing a location of each store, based on the second extracted store stored, and extracting a location of the second extracted store, and
generating map data in which a mark representing the second extracted store is disposed at the location of the second extracted store.

3. The search method according to claim 1, wherein
extracting information of the second extracted store includes
searching a commodity database, which stores data of a related item of each of the commodities, based on the targeted commodity, and extracting data of a related item of the targeted commodity, and
searching the stock database based on the data of the related item of the targeted commodity, and extracting information of a store which is the first extracted store and has related commodities, common to the data of the related item of the targeted commodity, in stock.

4. The search method according to claim 3, wherein
the related item is at least either a commodity category or a commodity producer.

5. The search method according to claim 1, wherein
extracting information of the second extracted store includes
extracting a store having a predetermined standard number or more of kinds of the related commodity.

6. The search method according to claim 1, further comprising:
specifying a uniquely-stocked commodity, for each second extracted store, from among the related commodities, which is not handled by another second extracted store, wherein
the transmitting includes transmitting data of the uniquely-stocked commodity to the search request source terminal.

7. A computer readable storage medium, storing a program of a search method which searches for a store handling commodities, and causes a computer to execute operations, comprising:
receiving a search keyword relating to a targeted commodity, as a condition of extracting information of a store which sells the targeted commodity, from a search request source terminal,
searching, based on the search keyword relating to the targeted commodity, a stock database of each store managing data relating to contents of commodities and stock data of the commodities, extracting information of a store having the targeted commodity in stock as a first extracted store, and storing corresponding information,
searching the stock database based on data of the targeted commodity, extracting information of a store indicated as the first extracted store and has in stock a related commodity relating to the data of the targeted commodity, as a second extracted store, and storing corresponding information, and
transmitting data of the second extracted store stored to the search request source terminal.

8. The storage medium in which the program is recorded according to claim 7, wherein
the transmitting includes
searching a store database storing a location of each store, based on the second extracted store stored in the storage device, and extracting a location of the second extracted store, and
generating map data in which a mark representing the second extracted store is disposed at the location of the second extracted store.

9. The storage medium in which the program is recorded according to claim 7, wherein
extracting information of the second extracted store includes
searching a commodity database, which stores data of a related item of each of the commodities, based on the targeted commodity, and extracting data of a related item of the targeted commodity, and
searching the stock database based on the data of the related item of the targeted commodity, and extracting a store which is the first extracted store and has related commodities, common to the data of the related item of the targeted commodity, in stock.

10. The storage medium in which the program is recorded according to claim 9, wherein
the related item is at least either a commodity category or a commodity producer.

11. The storage medium in which the program is recorded according to claim 7, wherein
extracting information of the second extracted store includes
extracting a store having a predetermined standard number or more of kinds of the related commodity.

12. The storage medium in which the program is recorded according to claim 7, further comprising:
specifying a uniquely-stocked commodity, for each second extracted store, from among the related commodities, which is not handled by another second extracted store, wherein
the transmitting includes transmitting data of the uniquely-stocked commodity to the search request source terminal.

13. A search apparatus, comprising:
a unit which receives a search keyword relating to a targeted commodity, as a condition of extracting information of a store which sells the targeted commodity, from a search request source terminal,
a unit which, by searching, based on the search keyword relating to the targeted commodity, a stock database of each store managing data relating to contents of commodities and stock data of the commodities, extracts information of each store having the targeted commodity in stock as a first extracted store, and stores corresponding information in a storage device,
a second extraction unit which, by searching the stock database based on data of the targeted commodity, extracts information of a store indicated as the first extracted store and has in stock a related commodity relating to the data of the targeted commodity, as a second extracted store, and stores corresponding information in the storage device, and
a transmission unit which transmits data of the second extracted store stored in the storage device to the search request source terminal.

14. The search apparatus according to claim 13, wherein
the transmission unit searches a store database storing a location of each store, based on the second extracted store stored in the storage device, and extracts a location of the second extracted store, and
generates map data in which a mark representing the second extracted store is disposed at the location of the second extracted store.

15. The search apparatus according to claim 13, wherein
the second extraction unit searches a commodity database, which stores data of a related item of each of the commodities, based on the targeted commodity, and extracts data of a related item of the targeted commodity, and
searches the stock database based on the data of the related item of the targeted commodity, and extracts a store which is the first extracted store and has related commodities, common to the data of the related item of the targeted commodity, in stock.

16. The search apparatus according to claim 15, wherein
the related item is at least either a commodity category or a commodity producer.

17. The search apparatus according to claim 13, wherein
the second extraction unit extracts a store having at least a predetermined standard number of kinds of the related commodity.

18. The search apparatus according to claim 13, further comprising:
a unit which, for each second extracted store, specifies a uniquely-stocked commodity, from among the related commodities, which is not handled by another second extracted store, wherein
the transmission unit transmits data of the uniquely-stocked commodity to the search request source terminal.

19. A method, comprising:
searching for a provider having a commodity requested by a user; and
displaying a result of said searching by editing data related to the provider, where said result includes information of the provider on a map and indicates whether the commodity is in stock.
